(19) United States
(12) Patent Application Publication
(10) Pub. No.: US 2025/0256335 A1
(43) Pub. Date: Aug. 14, 2025

(54) FOUR-WAY INDEXABLE CUTTING INSERT AND CUTTING TOOL

(71) Applicant: ISCAR, LTD., TEFEN (IL)

(72) Inventor: GIL HECHT, NAHARIYA (IL)

(73) Assignee: ISCAR, LTD., TEFEN (IL)

(21) Appl. No.: 18/439,937

(22) Filed: Feb. 13, 2024

(51) Int. Cl. B23B 27/14

(52) U.S. Cl. CPC B23B 27/145; B23B 2200/048

(57) ABSTRACT

A four-way indexable plate-shaped cutting insert that is indexable about a central insert axis and a cutting tool. The cutting includes a base body, a first insert side surface, a second insert side surface opposite the first insert side surface, a peripheral insert surface that connects the first insert side surface and the second insert side surface, and four cutting arms. The peripheral insert surface of each cutting arm includes a rake surface, a relief surface facing in the opposite direction, and a cutting edge formed at an intersection of the rake surface and the relief surface. The first insert side surface includes a first portion that is farther away from an insert median plane than the another portion thereof. The first insert abutment portion defines a coolant groove that is recessed in the first insert abutment portion. The coolant groove opening out to the first arm side portion.

### FIELD OF THE INVENTION

The subject matter of the present application relates to a four-way indexable cutting insert for metal turning operations. Specifically, the cutting insert is to be used in grooving and parting operations.

### BACKGROUND OF THE INVENTION

In the field of turning operations, specifically in metal machining operations, it is known to provide a four-way indexable cutting insert which is indexable via rotation of the insert along a central axis. For example, such cutting inserts are disclosed in JP6162544, DE102006017458, U.S. Pat. No. 4,169,690 and KR20180028569.

Also known is a four-way indexable cutting insert which is secured to an insert holder via abutment between three of the insert's four abutment zones, located at opposing imaginary quadrants, and the insert holder's three reaction zones, two reaction zones being located at a lower bulge and the remaining reaction zone being located at an upper bulge. For example, such a cutting insert is disclosed in U.S. Pat. No. 8,678,718.

It is an object of the subject matter of the present application to provide a cutting tool with improved repeatability and clamping. It is also an object of the subject matter of the present application to provide a cutting insert with improved repeatability.

### SUMMARY OF THE INVENTION

In accordance with an aspect of the subject matter of the present application there is provided a cutting tool including a tool holder, a four-way indexable plate-shaped cutting insert, and a fastener. The tool holder defines a central longitudinal holder axis, a forward holder direction extending in a direction parallel to the central longitudinal holder axis, and a rearward holder direction that is opposite the forward holder direction. The tool holder includes an insert coupling portion that includes a forward facing forward holder surface that is located at a forward tool end of the tool holder. The forward tool end delimits the tool holder in the forward holder direction. The insert coupling portion defines an insert seat that opens out through the forward facing forward holder surface. The insert seat is defined by a top holder abutment surface, a bottom holder abutment surface that opposes the top holder abutment surface, and a holder side abutment surface that connects the top holder abutment surface at the bottom holder abutment surface.

The four-way indexable plate-shaped cutting insert is releasably secured to the tool holder. The cutting insert is indexable about a central insert axis thereof. The cutting insert has a first axial insert direction along the central insert axis and a second insert direction along the central insert axis that is opposite the first axial insert direction. The cutting insert has a circumferential insert direction about the central insert axis. The cutting insert defines an insert median plane that is orthogonal to the central insert axis. The cutting insert includes a base body that is centered about the central insert axis, a first insert side surface, a second insert side surface opposite the first insert side surface, a peripheral insert surface, and four cutting arms. The insert median plane is disposed between the first insert side surface and the second insert side surface. The peripheral insert surface connects the first insert side surface and the second insert side surface. The four cutting arms are circumferentially distributed about the central insert axis. The four cutting arms including, in the circumferential insert direction, an active arm, an upper arm, an inner arm, and a lower arm. The active arm is the cutting arm that extends farthest in the forward holder direction and protrudes in the forward holder direction from the forward holder surface. Each cutting arm extends from the base body in a direction away from the central insert axis. The peripheral insert surface of each cutting arm includes a rake surface facing in the circumferential insert direction, a relief surface facing in the opposite direction, a cutting edge formed at an intersection of the rake surface and the relief surface, a top arm surface that extends from the rake surface towards the base body, and a bottom arm surface that extends from the relief surface towards the base body. The fastener releasably secures the cutting insert in the insert seat with abutting surfaces therebetween. The four pairs of abutting surfaces defined as the first insert side surface abutting the holder side abutment surface, the bottom arm surface of the upper arm abutting the top holder abutment surface, the bottom arm surface of the lower arm abutting the bottom holder abutment surface, and the top arm surface of the inner arm abutting the bottom holder abutment surface. In some embodiments, there are exactly four pairs of abutting surfaces.

In aspects, the tool holder includes a shank portion a top holder surface, and a front holder surface. The shank portion may include a rearward tool end that delimits the tool holder in the reward holder direction. The front holder surface and the top holder surface may be connected to one another and to the forward holder surface. The insert seat may open out through the front holder surface. The top holder surface may include a top coupling segment located in the insert coupling portion, a top shank segment located in the shank portion and closer to the central longitudinal holder axis than the top coupling segment, and a rearwardly facing coupling segment stopper located between the top coupling segment and the top shank segment. A tool overhang length OL may be defined parallel to the central longitudinal holder axis from the coupling segment stopper to the cutting edge of the active arm. An outer diameter OD of an imaginary circumscribing circle may be defined as the smallest circle circumscribing the cutting insert that fulfills the following condition: 0.7*OD≤OL≤1.2*OD. The holder overhang length may be defined parallel to the central longitudinal axis from the coupling segment stopper to the forward holder surface being in a range of 10 mm to 25 mm.

In certain aspects, an outer diameter OD belonging to an imaginary circumscribing circle may defined as the smallest circle that circumscribes the cutting insert and an inner diameter ID belonging to an imaginary inscribed circle may be defined as the largest circle inscribed by the cutting insert, which fulfills the following condition: 0.3*OD≤ID≤0.6*OD. The tool holder may further define an inlet and a top outlet in fluid communication with one another. The top outlet may open out to the forward holder surface. In a top view, the top outlet may be located directly in the rearward holder direction from the active arm.

In particular aspects, the first insert side surface includes a first insert abutment portion that is located in the base body. The first arm side portion may be located at the four cutting arms with the first insert abutment portion being farther away from the insert median plane than at least a portion of the first arm side portion. The second insert side surface may include a second insert abutment portion that is located at the base body and a second arm side portion that is located at the four cutting arms with the second insert abutment portion being farther away from the insert median plane than at least a portion of the second arm side portion. The first insert side surface may include a coolant groove that is recessed into the first insert abutment portion and opening out to the first arm side portion. The tool holder may define a side outlet and an inlet that are in fluid communication with one another. The side outlet may open out to the holder side abutment surface.

In accordance with another aspect of the subject matter of the present application there is provided a four-way indexable plate-shaped cutting insert that is indexable about a central insert axis. The cutting insert has a first axis insert direction along the central insert axis, a second insert direction along the central insert axis opposite the first axial insert direction, and a circumferential insert direction about the central insert axis. The cutting insert defines an insert median plane that is orthogonal to the central insert axis. The cutting insert includes a base body centered about the central insert axis, a first insert side surface, a second insert side surface opposite the first insert side surface with the insert median plane disposed between the first insert side surface and the second insert side surface, a peripheral insert surface that connects the first insert side surface and the second insert side surface, and four cutting arms that are circumferentially distributed about the central insert axis and extending from the base body in a direction away from the central insert axis. The peripheral insert surface of each cutting arm including a rake surface facing in the circumferential insert direction, a relief surface facing in the opposite direction, a cutting edge formed at an intersection of the rake surface and the relief surface, a top arm surface that extends from the relief surface towards the base body, and a bottom arm surface that extends from the relief surface towards the base body. The first insert side surface includes a first insert abutment portion that is located at the base body and a first arm side portion that is located at the four cutting arms. The first insert abutment portion is farther away from the insert median plane than the first arm side portion. The first insert abutment portion defines a coolant groove that is recessed in the first insert abutment portion. The coolant groove opening out to the first arm side portion.

In aspects there are exactly four cutting arms equally distributed about the central insert axis. An arm angle that is defined between the bottom arm surface of one of the four cutting arms and the top arm surface of an adjacent cutting arm is in a range of 80 degrees to 120 degrees.

In some aspects, the peripheral insert surface further includes four concave transition surfaces. Each transition surface may connect the bottom arm surface of one of the cutting arms and the top arm surface of an adjacent cutting arm. Each transition surface may be curved along an imaginary transition circle defining a transition radius in a range of 2 mm to 4 mm.

Further, to the extent consistent, any of the embodiments or aspects described herein may be used in conjunction with any or all of the other embodiments or aspects described herein.

### BRIEF DESCRIPTION OF THE FIGURES

For a better understanding of the present application and to show how the same may be carried out in practice, reference will now be made to the accompanying drawings, in which:

FIG. 1 is a perspective view of a portion of a cutting tool according to a first aspect of the present application;

FIG. 2 is an exploded view of the cutting tool shown in FIG. 1;

FIG. 3 is a perspective view of a cutting insert shown in FIG. 1;

FIG. 4 is a side view of the cutting insert shown in FIG. 3;

FIG. 5 is a first side view of the cutting insert shown in FIG. 3;

FIG. 6 is a second side view of the cutting insert shown in FIG. 3;

FIG. 7 is a perspective view of a tool holder shown in FIG. 1;

FIG. 8 is a first side view of the tool holder shown in FIG. 7;

FIG. 9 is a front view of the tool holder shown in FIG. 7;

FIG. 10 is a top view of the tool holder shown in FIG. 7;

FIG. 11 is an enlarged first side view of the cutting tool shown in FIG. 1;

FIG. 12 is a front view of the cutting tool shown in FIG. 1;

FIG. 13 is an enlarged top view of the cutting tool shown in FIG. 1; and

FIG. 14 is a first side view of the cutting tool shown in FIG. 1.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

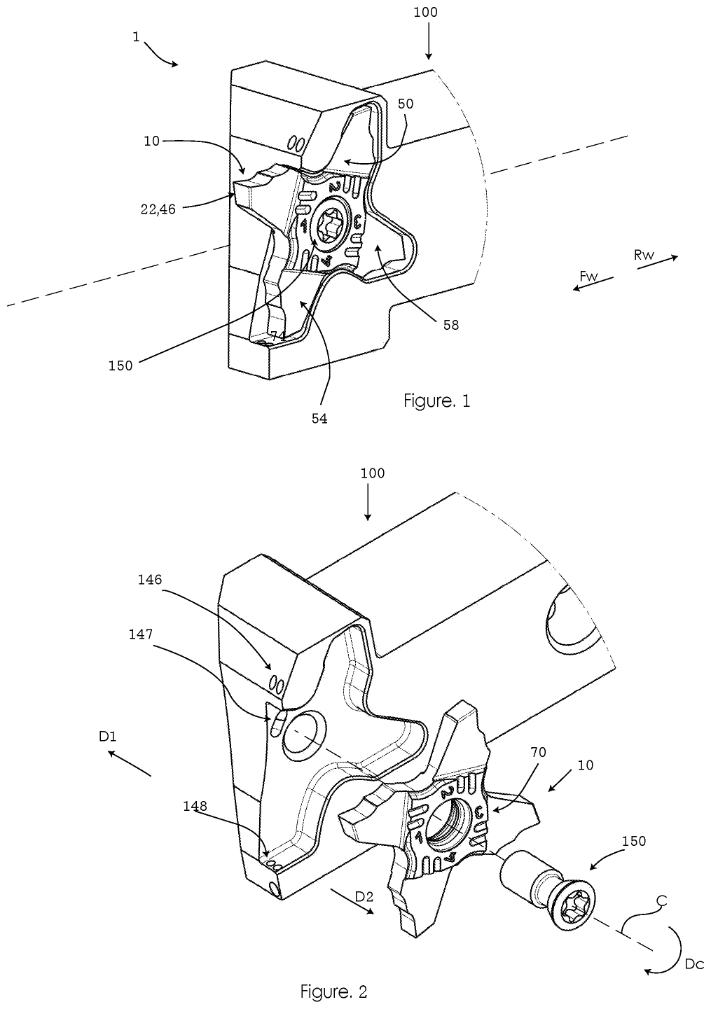

Attention is first drawn to FIGS. 1 and 2, showing a cutting tool 1 including a four-way indexable plate-shaped cutting insert 10 releasably secured to a tool holder 100 by a fastening means 150. The cutting insert 10 may be made from harder material than the tool holder 100, for example cemented carbide. As used herein, the term “plate-shaped” is directed to a disc shape or a short cylinder where the height is less than the diameter thereof.

The cutting insert 10 is indexable about a central insert axis C. The central insert axis C defines a circumferential insert direction Dc and opposing first and second axial insert directions D1, D2. The first and second axial insert directions D1, D2 are parallel to the central insert axis C, with the circumferential insert direction Dc being radial about the central insert axis C, e.g., clockwise when viewing the cutting insert in the first axial insert direction D1.

The tool holder 100 has a longitudinal holder axis L. The longitudinal holder axis L defines opposing forward and rearward holder directions Fw, Rw parallel to the longitudinal holder axis L.

As seen in FIGS. 3 to 6, the cutting insert 10 includes a base body 16, four cutting arms 22, first and second insert side surfaces 64, 70, and a peripheral insert surface 76. In some embodiments, the four cutting arms 22 are identical to one another. The base body 16 is centered about the central insert axis C. The four cutting arms 22 are circumferentially distributed about the central insert axis C. In some embodiments, the four cutting arms 22 are equally distributed about the central insert axis C.

In some embodiments, a central bore 18, centered about the central insert axis C, opens out to the first and second insert side surfaces 64, 70, at the base body. The central bore 18 may then be used to releasably secure the cutting inert 10 to the tool holder 100 using a fastening means 150 (for example, a fastener or screw 150 as seen in FIGS. 1 and 2).

Each cutting arm 22 extends from the base body 16 in a direction away from the central insert axis C. The first and second insert side surfaces 64, 70 are located on opposite sides of an insert median plane M. The insert median plane M is perpendicular to the central insert axis C. The peripheral insert surface 76 connects the first and second insert side surfaces 64, 70.

The first side surface 64 includes a first insert abutment portion 65 and a first arm side portion 66. The first insert abutment portion 65 is located at the base body 16 and the first arm side portion 66 is located at the four cutting arms 22. That is to say, in a top view, the first insert abutment portion 65 is confined by the base body 16 and the first arm side portion 66 is confined by each of the four cutting arms 22.

In some embodiments, the first insert abutment portion 65 is farther away from the median plane M than at least a portion of the first arm side portion 66. Creating such a difference in the location of the first insert abutment portion 65 and the first arm side portion 66 may ensure reliable abutment between the cutting insert 10 and the tool holder 100 when abutment is facilitated using the first insert side surface 64.

The second side surface 70 includes a second insert abutment portion 71 and a second arm side portion 72. The second insert abutment portion 71 is located at the base body 16 and the second arm side portion 72 is located at the four cutting arms 22. That is to say, in a top view, the second insert abutment portion 71 is confined by the base body 16 and the second arm side surface 72 is confined by each of the four cutting arms 22.

In some embodiments, the second insert abutment portion 71 is farther away from the median plane M than at least a portion of the second arm side portion 72. Specifically, the second insert abutment portion 71 may be farther away from the median plane M than the second arm side portion 72. As mentioned above, this is advantageous for having the cutting insert 10 abut the tool holder 100 with the second insert side surface 70.

In some embodiments, the first and second insert side surfaces 64, 70 are parallel to the insert median plane M. In particular embodiments, the first and second insert side surfaces 64, 70 are equally distanced from the insert median plane M. Further, the first and second insert side surfaces 64, 70 may exhibit mirror symmetry relative to one another about the insert median plane M. This mirror symmetry may allow using the cutting insert 10 for both left-hand and right-hand machining operations.

Each cutting arm 22 includes, at the peripheral insert surface 76, opposing rake and relief surfaces 26, 30, a cutting edge 34, and opposing top and bottom arm surfaces 38, 42. Differently worded, each section of the peripheral insert surface 76 constituting a part of one of the cutting arms 22 includes the above-specified features (i.e. surfaces 26, 30, 38, 42 and the cutting edge 34). The rake surface 26 faces in the circumferential insert direction Dc. The cutting edge 34 is formed at an intersection of the rake and relief surfaces 26, 30. The top arm surface 38 extends from the rake surface 26 towards the base body 16. The bottom arm surface 42 extends from the relief surface 30 towards the base body 16. A transition surface 40 connects adjacent top and bottom arm surfaces 38, 42, each belonging to a different cutting arm 22.

In some embodiments, the first insert side surface 64 may include at least one coolant groove 80. In certain embodiments, the first insert side surface 64 may include a plurality of coolant grooves 80. The at least one coolant groove 80 is recessed into the first insert abutment portion 65 and opens out to the first arm side portion 66. Such grooves may supply coolant to the cutting edge 34 from a side outlet 147 (mentioned below) during machining operations. The coolant grooves 80 may also direct the coolant more accurately to flow in the direction of the cutting edge 34.

Likewise, in some embodiments, the second insert side surface 70 may include at least one coolant groove 80. In certain embodiments, the first insert side surface 64 may include a plurality of coolant grooves 80. The at least one coolant groove 80 is recessed into the second insert abutment portion 71 and opens out to the second arm side portion 72.

Such coolant grooves 80 may be located farther away from the median plane M than the respective portion of either the first or second arm side portions 66, 72. Such embodiments, may allow the coolant grooves 80 to guide the coolant being supplied in a direction roughly parallel to the cutting insert 10. Further, this can be preferable to having grooves (not shown) serving a similar purpose recessed into the tool holder 100. For example, this may be preferable due to improved proximity of a channel created between the coolant groove 80 and the tool holder 100 to the cutting edge 34 during machining operations, which may in turn lead to better supply of coolant to the cutting edge 34.

In some embodiments, the cutting insert 10 further includes first and second cutting planes P1, P2. In a side view, the first cutting plane P1 connects the cutting edges 34 of two opposing cutting arms 22 out of the four cutting arms 22, and the second cutting plane P2 connects the cutting edges 34 of the two remaining cutting arms 22. The first and second cutting planes P1, P2 intersect one another at the central insert axis C. Specifically, the first and second cutting planes P1, P2 connect two cutting edges 34 opposing one another about the central insert axis C. In cases where the cutting edges 34 are not perpendicular to the side view (i.e., to the first insert side surface 64) the first and second cutting planes specifically connect the opposing cutting edges 34 at the extent of each cutting edge 34 farthest from the central insert axis C.

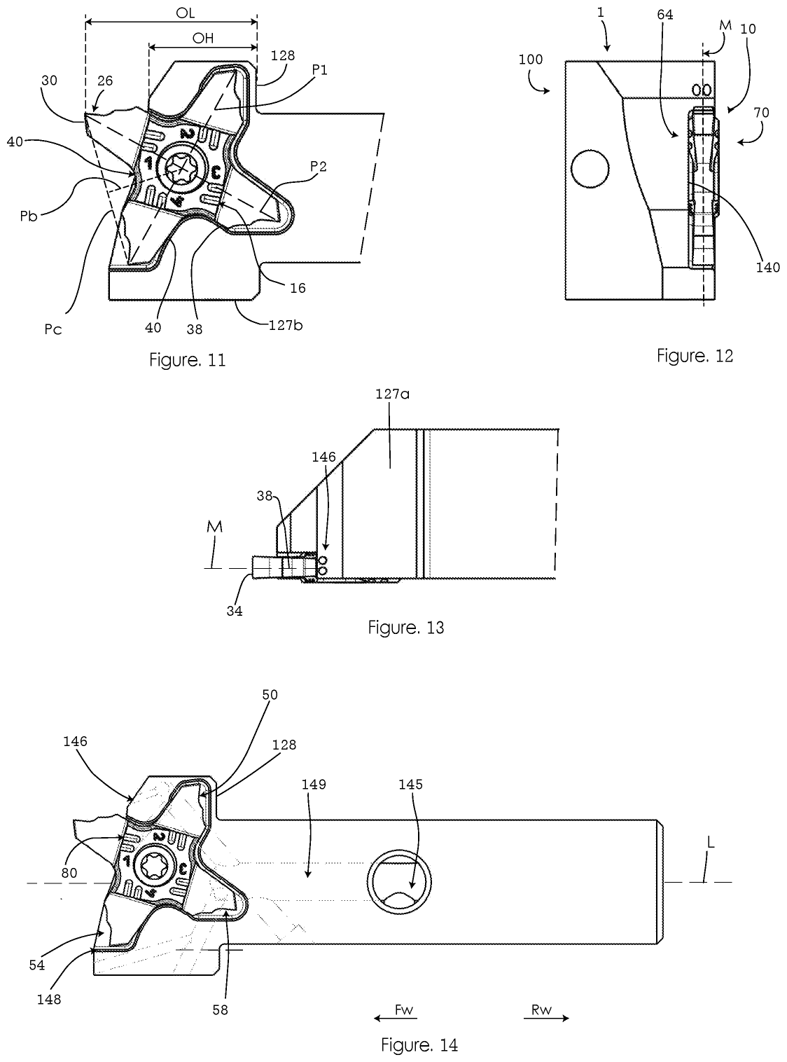

In some embodiments, as seen in FIG. 11, the first and second cutting planes P1, P2 are located closer to the bottom arm surfaces 42 belonging to their respective cutting arms 22 than to their respective top arm surfaces 38. Respective cutting arms 22 refers to cutting arms 22 which include the cutting edges 34 which are connected by the first and second cutting planes P1, P2, respectively. In other words, the first and second cutting planes P1, P2 each splits two different opposing cutting arms 22 out of the four cutting arms, with the bottom arm surface 42 of each opposing pair of cutting arms 22 being located closer to the first and second cutting planes P1, P2, respectively, than the top arm surface 38 of each opposing pair of cutting arms 22. Such geometrical constraints can help to ensure that the positioning of the cutting insert 10 in the tool holder 100 is a desirable one, taking into account the forces arising during machining operations.

In some embodiments, the cutting insert 10 includes a bisector plane Pb and an edge connector plane Pc. The edge connector plane Pc connects two adjacent cutting edges 34. The bisector plane Pb is perpendicular to the edge connector plane Pc and the central insert axis C lies within the bisector plane Pb. In some embodiments, in a side view as seen in FIG. 11, the bisector plane Pb further passes through the respective transition surface 40. The respective transition surface 40 is located between the connected cutting edges 34. Such geometrical constraints can help to ensure that the positioning of the cutting insert 10 in the tool holder 100 is desirable.

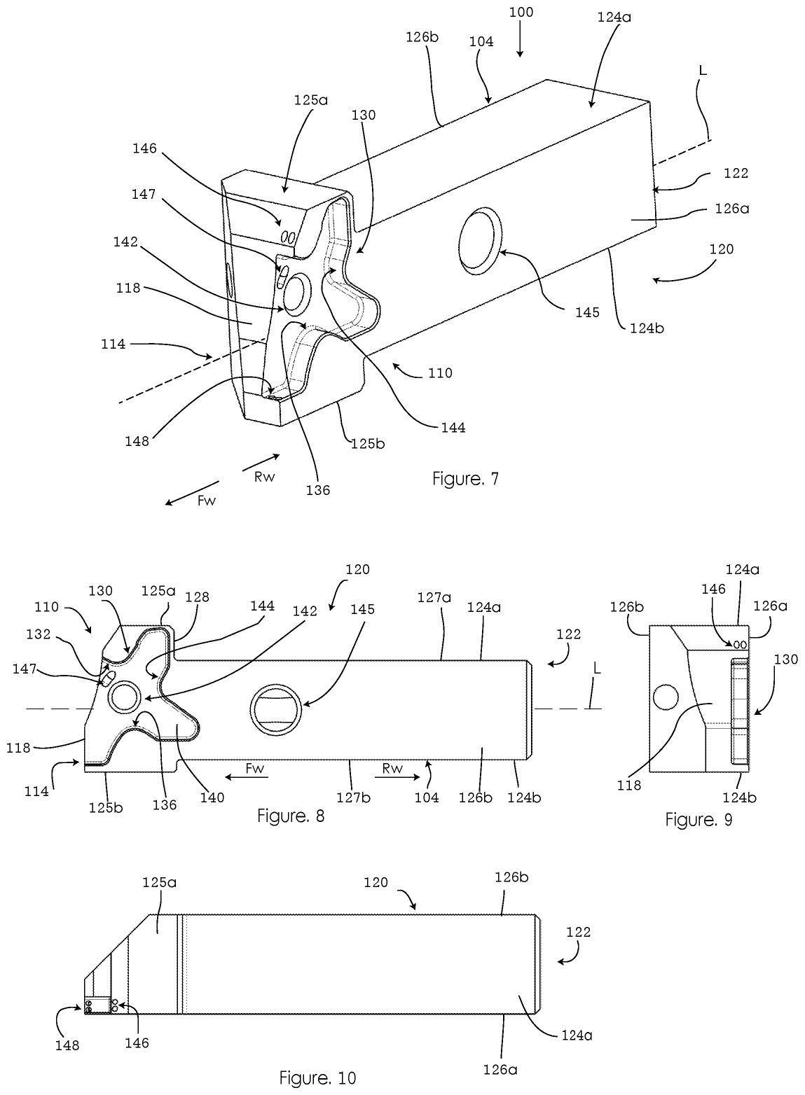

Referring now to FIGS. 7 to 10, the tool holder 100 includes a peripheral holder portion 104 and an insert coupling portion 110. The tool holder 100 may further include a shank portion 120 located rearwardly of the insert coupling portion 110. The peripheral holder portion 104 extends about the longitudinal holder axis L.

In some embodiments, the peripheral holder portion 104 includes opposing top and bottom holder surfaces 124a, 124b and opposing front and back holder surfaces 126a, 126b connecting the top and bottom holder surfaces 124a, 124b. At the shank portion 120, the peripheral holder portion 104 may have a rectangular cross-section. The shank portion 120 may include a rearward tool end 122 delimiting the tool holder 100 in the rearward holder direction Rw. The top, bottom, front, and back holder surfaces 124a, 124b, 126a, 126b may extend from the rearward tool end 122 to a forward tool end 114.

In some embodiments, the top holder surface 124a may include a top coupling segment 125a and a top shank segment 127a. The bottom holder surface 124b may include a bottom coupling segment 125b and a bottom shank segment 127b. The top and bottom coupling segments 125a, 125b are located at the insert coupling portion 110. The top and bottom shank segments 127a, 127b are located at the shank portion 120. A rearwardly facing coupling segment stopper 128 may be located between the top coupling segment 125a and the top shank segment 127a. The top and bottom shank segments 127a, 127b may be closer to the longitudinal holder axis L than the top and bottom coupling segments 125a, 125b, respectively. This may be done, for example, to ensure that the extent of the cutting tool 1 is easily repeatable when placed in a turret (or its equivalent).

The insert coupling portion 110 includes the forward tool end 114, a forwardly facing forward holder surface 118 and an insert seat 130. The forward tool end 114 delimits the tool holder 100 in the forward holder direction Fw. The forward holder surface 118 faces in the forward holder direction Fw and is located at the forward tool end 114. In some embodiments, the forward holder surface 118 delimits the tool holder 100 in the forward holder direction Fw.

The insert seat 130 is recessed in the peripheral holder portion 104 and opens out to the forward holder surface 118. In some embodiments, the insert seat 130 further opens out to the front holder surface 126a. The insert seat 130 includes a top holder abutment surface 132, a bottom holder abutment surface 136 and a holder side abutment surface 140. The top and bottom holder abutment surfaces 132, 136 oppose one another. In some embodiments, the top and bottom holder abutment surfaces 132, 136 oppose one another about the longitudinal holder axis L. The holder side abutment surface 140 connects the top and bottom holder abutment surfaces 132, 136. The insert seat 130 may further include a forwardly facing rear surface 144.

In some embodiments, a fastening bore 142 opens out to the holder side abutment surface 140. The fastening means 150 engages the fastening bore 142 and clamps the cutting insert 10, through the central bore 18, to the holder side abutment surface 140.

When the cutting tool 1 is assembled, for example as seen in FIGS. 11 to 14, a fastening means 150, for example a screw passing through the central bore 18 as shown in the present embodiment, releasably secures the cutting insert 10 to the insert seat 130 of the tool holder 100. On assembly, one of the cutting arms 22 extends farther in the forward holder direction Fw relative to the other cutting arms 22. The forwardmost cutting arm 22 will hereinafter be interchangeably referred to as an “active arm 46”. The active arm 46 extends farthest in the forward holder direction Fw and protrudes outwards of the forward holder surface 118.

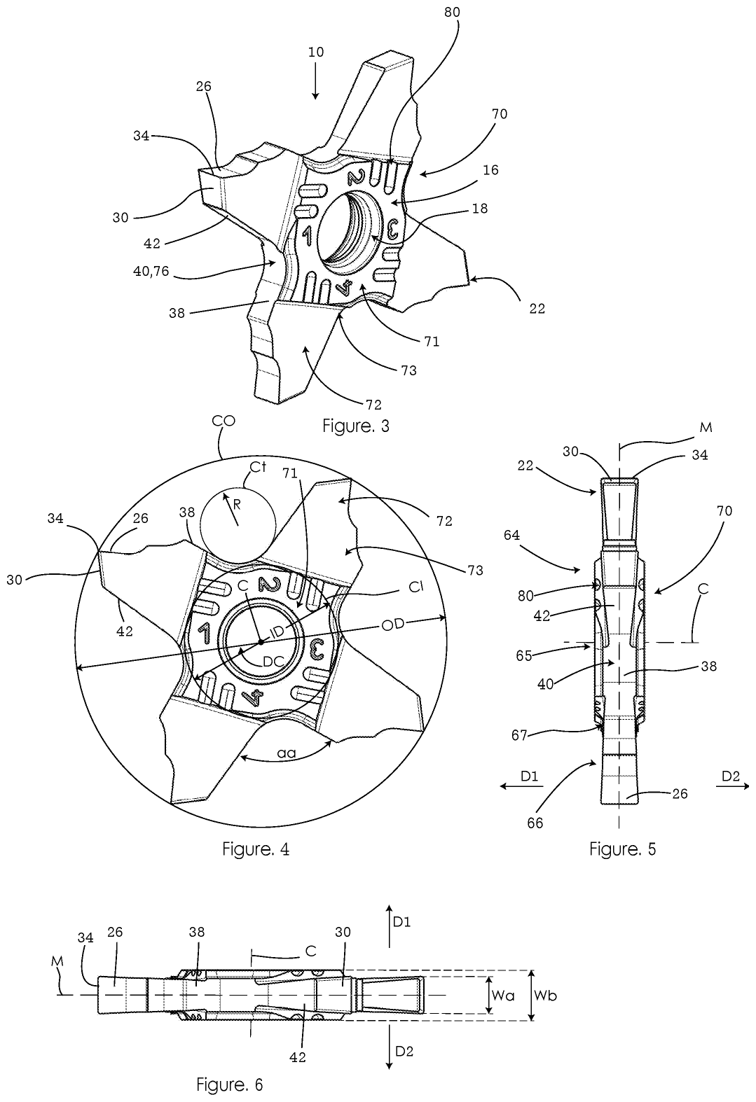

In some embodiments, as seen in FIGS. 4 and 11, a tool overhang length OL and an outer diameter OD fulfill the following condition: 0.7*OD≤OL≤1.2*OD. In some embodiments, the tool overhang length OL and the outer diameter OD further fulfill the following condition: 0.8*OD≤OL≤OD. The tool overhang length OL is defined as parallel to the longitudinal holder axis L and is measured from the coupling segment stopper 128 to the cutting edge 34 of the active arm 46. The outer diameter OD is the diameter of an imaginary circumscribing circle CO, defined as the smallest circle circumscribing the cutting insert 10. The greater the tool overhang length OL is, the more the cutting tool 1 may be prone to unfavorable conditions such as, for example, vibrations. Thus, it may be advantageous to minimize the tool overhang length OL. Due to the dimensions of the cutting insert 10 relative to those of the tool holder 100, the tool overhang length may depend on the outer diameter OD, among other considerations. Thus, the above-mentioned ratio was found desirable in consideration of things such as forces arising during machining operations and the possible positioning of the cutting insert 10 relative to the tool holder 100.

It will be noted that such a dependency as specified above may not always be true. For example, this may be irrelevant in cases where the tool holder 100 has a greater height than the cutting insert 10 because the coupling segment stopper 128 can then be chosen to be located anywhere on the tool holder 100. However, in the embodiments shown in FIGS. 1 to 14, the cutting insert 10 extends beyond the tool holder 100, meaning that there are constraints on the tool overhang length OL.

In some embodiments, with the outer diameter OD fulfilling the following condition: 26 mm≤OD≤34 mm, a holder overhang length OH may fulfill the following condition: 10 mm≤OH≤25 mm. In some embodiments, the holder overhang length OH further fulfills the following condition: 12 mm≤OH≤20 mm. Specifically, the holder overhang length OH may further fulfill the following condition: 13 mm≤OH≤17 mm. The holder overhang length OH is defined parallel to the longitudinal holder axis L and is measured from the coupling segment stopper 128 to the forward holder surface 118. Smaller values of the holder overhang length OH may negatively impact the rigidity of the clamping of the cutting insert 10 in the insert seat. For example, more vibrations may occur during machining operations due to weakening of the top holder abutment surface 132. Larger values of the holder overhang length OH can shorten the extent of the cutting insert 10 which can participate in the cutting operations. Thus, taking the aforementioned considerations, the above condition is found desirable.

In some embodiments, the outer diameter OD and an inner diameter ID fulfill the following condition: 0.3*OD≤ID≤0.6*OD. The inner diameter ID is the diameter of an imaginary inscribed circle CI, defined as the largest circle circumscribed by the cutting insert 10. The larger the inner diameter ID is, the shorter the cutting arms 22 are, which can negatively impact the depth of cut possible during machining. At the same time, smaller values of the inner diameter ID may mean that the cutting insert 10 is weaker (for example, due to the central bore 18). The above-mentioned ratio is desirable given these considerations.

The fastening means 150 clamps the cutting insert 10, biasing the cutting insert 10 in the first axial insert direction D1. In some embodiments, the fastening means 150 further biases the cutting insert 10 in the forward holder direction Fw and in a direction towards the bottom holder abutment surface 136. This may ensure repeatability and that there are exactly four abutment sections between the cutting insert 10 and the tool holder 100 as explained below.

The first insert side surface 64 abuts the holder side abutment surface 140. The bottom arm surface 42 of an upper arm 50 abuts the top holder abutment surface 132. The bottom arm surface 42 of a lower arm 54 abuts the bottom holder abutment surface 136. The top arm surface 38 of an inner arm 58 abuts the bottom holder abutment surface 136. In some embodiments, the abutment between the top and bottom arm surfaces 38, 42 and the tool holder 100 occurs adjacent to transition surfaces 40. This may ensure that the cutting insert 10 is more securely fastened to the tool holder 100.

The upper arm 50 is defined as the cutting arm 22 rotationally adjacent the active arm 46 in the circumferential insert direction Dc. The lower arm 54 is defined as the cutting arm 22 rotationally adjacent the active arm 46 in a direction opposite to the circumferential direction Dc. The inner arm 58 is defined as the cutting arm 22 rotationally adjacent the upper and lower arms 50, 54.

In some embodiments, there are exactly four concave transition surfaces 40, each transition surface 40 connecting the bottom arm surface 42 of one of the cutting arms 22 and the top arm surface 38 of an adjacent cutting arm 22. Specifically, each transition surface 40 connects one of the top arm surfaces 38 to the bottom arm surface 42 rotationally adjacent to said top arm surface 38 in the circumferential insert direction Dc. The transition surfaces 40 are spaced apart from the tool holder 100. The transition surfaces 40 being concave can ensure that the areas of abutment between the top and bottom arm surfaces 38, 42 and the tool holder 100 are closer to the central insert axis C (relative to flat or convex transition surfaces 40). Specifically, in some embodiments, the areas of abutment of the bottom arm surface 42 of an upper arm 50, the bottom arm surface 42 of a lower arm 54, and the top arm surface 38 of an inner arm 58 with the tool holder 100 are located adjacent to the respective transition surfaces 40.

In some embodiments, each transition surface 40 is concavely curved, in a top view, along an imaginary transition circle Ct. A transition radius R of the imaginary transition circle Ct fulfills the following condition: 2 mm≤R≤4 mm. In some embodiments, the transition radius R further fulfills the following condition: 2.4 mm≤R≤3.6 mm. In certain embodiments, the transition radius R further fulfills the following condition: 2.7 mm≤R≤3.3 mm.

Larger values of the transition radius R may mean a larger transition surface 40 which cuts into the top and bottom arm surfaces 38, 42. This causes the abutment between the cutting insert 10 and the tool holder 100, which as discussed above does not happen at the transition surfaces 40 which are spaced apart from the tool holder 100, to be located farther away from the base body 16. Abutment between the cutting insert 10 and the tool holder 100 may be as close as possible to the base body 16. This may, for example, ensure stability of the cutting insert 10.

Smaller values of the transition radius R may mean a smaller transition surface 40. This causes the top and bottom arm surfaces 38, 42 to be elongated, taking material away from the base body 16 which may compromise the rigidity and lifespan of the cutting insert 10. Thus, advantageous values of the transition radius R were found, striking a balance between the length of the top and bottom arm surfaces 38, 42, which affect the location of the abutment between the cutting insert 10 and the tool holder 100, and the size of the base body 16.

In some embodiments, as seen in FIG. 4, an arm angle aa is defined between the bottom arm surface 42 of one of the four cutting arms 22 and the top arm surface 38 of an adjacent cutting arm 22. That is to say, the arm angle aa is defined between adjacent top and bottom arm surfaces 38, 42, each surface belonging to a different one of the four cutting arms 22. The adjacent top and bottom arm surfaces 38, 42 are connected to one another via a respective one of the four transition surfaces 40.

The arm angle aa may fulfill the following condition: 80 degrees≤aa≤120 degrees. In embodiments, the arm angle aa fulfills the following condition: 90 degrees≤aa≤110 degrees. In some embodiments, the arm angle aa fulfills the following condition: 95 degrees≤aa≤100 degrees. For greater values of the arm angle aa each of the cutting arms 22 may be sturdier and less inclined to vibrations. For smaller values of the arm angle aa each of the cutting arms 22 may extend farther from the base body 16. Thus, advantageous values of the arm angle aa were found, which strike a balance between the length of the cutting arms 22 and their resilience.

In some embodiments, as shown in FIGS. 7 to 10 and 12 to 14, the tool holder 100 may include a fluid system to supply the cutting edge 34 with coolant and/or lubricant during machining operations. In such case the tool holder 100 includes at least one inlet 145 and at least one outlet. Specifically, the outlet may be a top outlet 146, a side outlet 147, a bottom outlet 148 or any combination thereof in the case of more than one outlet. Any of the top, side and bottom outlets 146, 147, 148 are in fluid communication with at least one inlet 145. In some embodiments, there may be a plurality of inlets 145, allowing the passage of coolant from different locations for ease of access.

The top outlet 146 opens out in the forward holder direction Fw on a portion of the forward holder surface 118 located near the insert seat 130. Specifically, when the cutting tool 1 is assembled, the top outlet 146 may open out to the forward holder surface 118, intersecting the insert median plane M, as shown in the top view seen in FIG. 13. Specifically, upon assembly of the cutting tool 1, the top outlet 146 may be located directly in the rearward holder direction Rw from the active arm 46. This may be advantageous as such a configuration allows coolant to be easily supplied directly to the cutting edge 34 of the active arm 46 when inside a groove being machined during machining operations.

The bottom outlet 148 opens out facing the longitudinal holder axis L. Specifically, the bottom outlet 148 may open out to an extension of the bottom holder abutment surface 136. More specifically, when the cutting tool 1 is assembled, the bottom outlet 148 may intersect the insert median plane M.

In some embodiments, as shown in FIG. 6, the base body 16 of the cutting insert 10 has a greater width than the cutting arms 22 of the cutting insert 10. Differently worded, a base width Wb may be greater than an arm width Wa. The base width Wb is defined, at the base body 16, as parallel to the central insert axis C and measured between the first and second insert side surfaces 64, 70. The arm width Wa is defined, at the cutting arms 22, as parallel to the central insert axis C and measured between the first and second insert side surfaces 64, 70.

In some embodiments, the base width Wb and the arm width Wa fulfill the following condition: 0.5*Wb≤Wa≤Wb. Specifically, the base width Wb and the arm width Wa may further fulfill the following condition: 0.55*Wb≤Wa≤0.9*Wb. More specifically, the base width Wb and the arm width Wa may further fulfill the following condition: 0.6*Wb≤Wa≤0.8*Wb. Lower values of the arm width Wa may, for example, lead to a less stable abutment between the cutting insert 10 and the tool holder 100.

In some embodiments, the base body 16 includes coolant grooves 80, recessed into one, or both, of the first and second insert side surfaces 64, 70. The coolant grooves 80 open out the cutting arms 22 and may each be directed towards one of the four cutting edges 34. In some embodiments, for a better coolant supply effect, each of the coolant grooves 80 may be elongated in a direction from the central bore 18 towards the one of the four cutting arms 22 closest thereto.

The side outlet 147 opens out to the holder side abutment surface 140. In some embodiments, the side outlet 147 may open out of the holder side abutment surface 140 closer to the forward holder surface 118 than the fastening bore 142. On assembly of the cutting tool 1, the side outlet 147 directly faces at least one of the coolant grooves 80 mentioned above, and together they supply and direct coolant to the cutting insert 10. More specifically, the coolant directed by the coolant grooves 80 may be directed to the cutting edge 34 of the active arm 46, during machining operations. This may be achieved by having the coolant grooves 34 being elongated in a direction towards the cutting edge 34, for example.

In some embodiments, as seen in FIG. 5, the first insert side surface 64 may further include a first arm abutment portion 67. The first arm abutment portion 67 is located at the four cutting arms 22 (i.e., each cutting arm 22 may include a first arm abutment portion 67). The first arm abutment portion 67 connects the first insert abutment portion 65 and the first arm side portion 66. The first arm abutment portion 67 may be located farther away from the median plane M relative to the first arm side portion 66 (not shown). In cases where, for thin cutting inserts (for example inserts with a cutting edge width of less than 1 mm), the abutment between the cutting insert 10 and the tool holder 100 takes place at the cutting arms 22, it may be necessary to thicken the cutting arms 22 at the abutment areas to ensure stable abutment. This may hamper the cutting insert 10 from entering machined grooves as deep as it otherwise could, however this results in wider top and bottom arm surfaces 38, 42 which may result in better clamping of the cutting insert 10 to the tool holder 100.

Likewise, the second insert side surface 70 may further include a second arm abutment portion 73. The second arm abutment portion 73 is located at the four cutting arms 22 (i.e., each cutting arm 22 may include a second arm abutment portion 73). The second arm abutment portion 73 connects the second insert abutment portion 71 and the second arm side portion 72. The second arm abutment portion 73 may be located farther away from the median plane M relative to the second arm side portion 72 (not shown).

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed is:

1. A cutting tool comprising:
a tool holder defining a central longitudinal holder axis, a forward holder direction extending in a direction parallel to the central longitudinal holder axis, and a rearward holder direction opposite the forward holder direction, the tool holder including an insert coupling portion comprising a forward facing forward holder surface located at a forward tool end of the tool holder, the forward tool end delimiting the tool holder in the forward holder direction, the insert coupling portion defining an insert seat, the insert seat opens out through the forward facing forward holder surface, the insert seat defined by:
a top holder abutment surface;
a bottom holder abutment surface opposing the top holder abutment surface; and
a holder side abutment surface connecting the top holder abutment surface and the bottom holder abutment surface;
a four-way indexable plate-shaped cutting insert releasably secured to the tool holder, the cutting insert being indexable about a central insert axis thereof, the cutting insert having a first axial insert direction along the central insert axis, a second insert direction along the central insert axis opposite the first axial insert direction, and a circumferential insert direction about the central insert axis, the cutting insert defining an insert median plane orthogonal to the central insert axis, the cutting insert comprising:
a base body centered about the central insert axis;
a first insert side surface;
a second insert side surface opposite the first insert side surface, the insert median plane disposed between the first insert side surface and the second insert side surface;
a peripheral insert surface connecting the first insert side surface and the second insert side surface; and
four cutting arms circumferentially distributed about the central insert axis, the four cutting arms including, in the circumferential insert direction, an active arm, an upper arm, an inner arm, and a lower arm, the active arm being the cutting arm that extends farthest in the forward holder direction and protrudes in the forward holder direction from the forward holder surface, each cutting arm extending from the base body in a direction away from the central insert axis, the peripheral insert surface of each cutting arm comprising:
a rake surface facing in the circumferential insert direction;
a relief surface facing in a circumferential direction opposite the circumferential insert direction;
a cutting edge formed at an intersection of the rake surface and the relief surface;
a top arm surface extending from the rake surface towards the base body; and
a bottom arm surface extending from the relief surface towards the base body;
a fastener releasably securing the cutting insert in the insert seat with exactly four pairs of abutting surfaces therebetween defined as:
the first insert side surface abutting the holder side abutment surface;
the bottom arm surface of the upper arm abutting the top holder abutment surface;
the bottom arm surface of the lower arm abutting the bottom holder abutment surface; and
the top arm surface of the inner arm abutting the bottom holder abutment surface.

2. The cutting tool according to claim 1, wherein the tool holder further comprises:
a shank portion comprising a rearward tool end, the rearward tool end delimiting the tool holder in the rearward holder direction;
a top holder surface; and
a front holder surface, the top holder surface and the front holder surface connected to one another and to the forward holder surface.

3. The cutting tool according to claim 2, wherein:
the insert seat opens out through the front holder surface;
the top holder surface comprises:
a top coupling segment located in the insert coupling portion;
a top shank segment located in the shank portion and closer to the central longitudinal holder axis than the top coupling segment; and
a rearwardly facing coupling segment stopper located between the top coupling segment and the top shank segment;
a tool overhang length OL defined parallel to the central longitudinal holder axis from the coupling segment stopper to the cutting edge of the active arm; and
an outer diameter OD of an imaginary circumscribing circle, defined as the smallest circle circumscribing the cutting insert, fulfills the following condition: 0.7*OD≤OL≤1.2*OD.

4. The cutting tool according to claim 3, wherein a holder overhang length, defined parallel to the central longitudinal holder axis from the coupling segment stopper to the forward holder surface, is in a range of 10 mm to 25 mm.

5. The cutting tool according to claim 1, wherein an outer diameter OD belonging to an imaginary circumscribing circle, defined as the smallest circle circumscribing the cutting insert, and an inner diameter ID belonging to an imaginary inscribed circle, defined as the largest circle inscribed by the cutting insert, fulfills the following condition: 0.3*OD≤ID≤0.6*OD.

6. The cutting tool according to claim 1, wherein the tool holder further defines an inlet and a top outlet, the top outlet in fluid communication with the inlet, the top outlet opening out to the forward holder surface; and wherein in a top view, the top outlet is located directly in the rearward holder direction from the active arm.

7. The cutting tool according to claim 1, wherein the first insert side surface comprises a first insert abutment portion, located at the base body, and a first arm side portion, located at the four cutting arms, the first insert abutment portion being farther away from the insert median plane than at least a portion of the first arm side portion.

8. The cutting tool according to claim 7, wherein the second insert side surface comprises a second insert abutment portion, located at the base body, and a second arm side portion, located at the four cutting arms, the second insert abutment portion being farther away from the insert median plane than at least a portion of the second arm side portion.

9. The cutting tool according to claim 7, wherein the first insert side surface further comprises a coolant groove recessed into the first insert abutment portion and opening out to the first arm side portion, the tool holder defining a side outlet and an inlet, the side outlet in fluid communication with the inlet, the side outlet opening out to the holder side abutment surface.

10. A four-way indexable plate-shaped cutting insert indexable about a central insert axis, the cutting insert having a first axial insert direction along the central insert axis, a second insert direction along the central insert axis opposite the first axial insert direction, and a circumferential insert direction about the central insert axis, the cutting insert defining an insert median plane orthogonal to the central insert axis, the cutting insert comprising:
a base body centered about the central insert axis;
a first insert side surface;
a second insert side surface opposite the first insert side surface with the insert median plane disposed between the first insert side surface and the second insert side surface;
a peripheral insert surface connecting the first insert side surface and second insert side surface; and
four cutting arms circumferentially distributed about the central insert axis and extending from the base body in a direction away from the central insert axis, the peripheral insert surface of each cutting arm comprising:
a rake surface facing in the circumferential insert direction;
a relief surface facing in a circumferential direction opposite the circumferential insert direction;
a cutting edge formed at an intersection of the rake surface and the relief surface;
a top arm surface extending from the rake surface towards the base body; and
a bottom arm surface extending from the relief surface towards the base body;
wherein the first insert side surface comprises a first insert abutment portion, located at the base body, and a first arm side portion, located at the four cutting arms, the first insert abutment portion being farther away from the insert median plane than the first arm side portion, the first insert abutment portion defining a coolant groove recessed in the first insert abutment portion, the coolant groove opening out to the first arm side portion.

11. The cutting insert according to claim 10, wherein there are exactly four cutting arms equally distributed about the central insert axis.

12. The cutting insert according to claim 11, wherein an arm angle, defined between the bottom arm surface of one of the four cutting arms and the top arm surface of an adjacent cutting arm, is in a range of 80 degrees to 120 degrees.

13. The cutting insert according to claim 10, wherein the peripheral insert surface further comprises four concave transition surfaces, each transition surface connecting the bottom arm surface of one of the cutting arms and the top arm surface of an adjacent cutting arm.

14. The cutting insert according to claim 13, wherein each transition surface is curved along an imaginary transition circle defining a transition radius in a range of 2 mm to 4 mm.

15. A cutting tool comprising:
a tool holder defining a central longitudinal holder axis, a forward holder direction extending in a direction parallel to the central longitudinal holder axis, and a rearward holder direction opposite the forward holder direction, the tool holder including an insert coupling portion comprising a forward facing forward holder surface located at a forward tool end of the tool holder, the forward tool end delimiting the tool holder in the forward holder direction, the insert coupling portion defining an insert seat, the insert seat opens out through the forward facing forward holder surface, the insert seat defined by:
a top holder abutment surface;
a bottom holder abutment surface opposing the top holder abutment surface; and
a holder side abutment surface connecting the top holder abutment surface and the bottom holder abutment surface;
a four-way indexable plate-shaped cutting insert releasably secured to the tool holder, the cutting insert being indexable about a central insert axis thereof, the cutting insert having a first axial insert direction along the central insert axis, a second insert direction along the central insert axis opposite the first axial insert direction, and a circumferential insert direction about the central insert axis, the cutting insert defining an insert median plane orthogonal to the central insert axis, the cutting insert comprising:
a base body centered about the central insert axis;
a first insert side surface;
a second insert side surface opposite the first insert side surface, the insert median plane disposed between the first insert side surface and the second insert side surface;
a peripheral insert surface connecting the first insert side surface and second insert side surface;
four cutting arms circumferentially distributed about the central insert axis, the four cutting arms including, in the circumferential insert direction, an active arm, an upper arm, an inner arm, and a lower arm, the active arm being the cutting arm that extends farthest in the forward holder direction and protrudes in the forward holder direction from the forward holder surface, each cutting arm extending from the base body in a direction away from the central insert axis, the peripheral insert surface of each cutting arm comprising:
a rake surface facing in the circumferential insert direction;
a relief surface facing in a circumferential direction opposite the circumferential insert direction;
a cutting edge formed at an intersection of the rake surface and the relief surface;
a top arm surface extending from the rake surface towards the base body; and
a bottom arm surface extending from the relief surface towards the base body;
a fastener releasably securing the cutting insert in the insert seat with four pairs of abutting surfaces therebetween defined as:
the first insert side surface abutting the holder side abutment surface;
the bottom arm surface of the upper arm abutting the top holder abutment surface;
the bottom arm surface of the lower arm abutting the bottom holder abutment surface; and
the top arm surface of the inner arm abutting the bottom holder abutment surface.

16. The cutting tool according to claim 15, wherein an outer diameter belonging to an imaginary circumscribing circle, defined as the smallest circle circumscribing the cutting insert, and an inner diameter belonging to an imaginary inscribed circle, defined as the largest circle inscribed by the cutting insert, fulfills the following condition: 0.3*OD≤ID≤0.6*OD.

17. The cutting tool according to claim 15, wherein the tool holder further defines an inlet and a top outlet, the top outlet in fluid communication with the inlet, the top outlet opening out to the forward holder surface; and wherein in a top view, the top outlet is located directly in the rearward holder direction from the active arm.

18. The cutting tool according to claim 15, wherein the first insert side surface comprises a first insert abutment portion, located at the base body, and a first arm side portion, located at the four cutting arms, the first insert abutment portion being farther away from the insert median plane than at least a portion of the first arm side portion.

19. The cutting tool according to claim 18, wherein the second insert side surface comprises a second insert abutment portion, located at the base body, and a second arm side portion, located at the four cutting arms, the second insert abutment portion being farther away from the insert median plane than at least a portion of the second arm side portion.

20. The cutting tool according to claim 18, wherein the first insert side surface further comprises a coolant groove recessed into the first insert abutment portion and opening out to the first arm side portion, the tool holder defining a side outlet and an inlet, the side outlet in fluid communication with the inlet, the side outlet opening out to the holder side abutment surface.
